(19) United States
(12) Patent Application Publication
(10) Pub. No.: US 2024/0092037 A1
(43) Pub. Date: Mar. 21, 2024

(54) Conforming 2D Composite Sheets To 3D Curved Surfaces With Optimal Mechanical Performance

(71) Applicants: The Trustees of the University of Pennsylvania, Philadelphia, PA (US); The United States Of America As Represented By Secretary Of the Army, Washington, DC (US)

(72) Inventors: Shu Yang, Blue Bell, PA (US); Lishuai Jin, Philadelphia, PA (US); Daniel J O'Brien, Hydes, MD (US); Michael Yeager, Aberdeen, MD (US)

(21) Appl. No.: 18/173,243

(22) Filed: Feb. 23, 2023

Related U.S. Application Data
(60) Provisional application No. 63/318,134, filed on Mar. 9, 2022.

(51) Int. Cl. B29C 70/22; G06F 30/17

(52) U.S. Cl. CPC B29C 70/222; G06F 30/17; G06F 2119/18

(57) ABSTRACT

A method, comprising: with a cutting graph corresponding to a two-dimensional (2-D) representation of a polyhedral mesh that is representative of the 3-D target object, forming i sheets in conformity with the cutting graph, i being from 1 to n, an i-th 2-D sheet having an i-th set of cuts formed therein, an (i+1)-th 2-D sheet having a (i+1)-th set of cuts formed therein, the (i+1)-th set of cuts optionally differing from the i-th set of cuts.

A 3-D composite object having a surface, the 3-D composite object comprising: i stacked and consolidated sheets, i being from 1 to n, an i-th sheet having an i-th set of cuts formed therein, an (i+1)-th sheet having a (i+1)-th set of cuts formed therein, the (i+1)-th set of cuts optionally differing from the i-th set of cuts.

### CROSS-REFERENCE TO RELATED APPLICATIONS

This application claims priority to and the benefit of U.S. Provisional Patent Application No. 63/318,134, “Conforming 2D Composite Sheets To 3D Curved Surfaces With Optimal Mechanical Performance” (filed Mar. 9, 2022), the entirety of which is incorporated by reference herein in its entirety for any and all purposes.

### GOVERNMENT RIGHTS

This invention was made with government support under W911NF-18-1-0327 awarded by the Army Research Laboratory-Army Research Office. The government has certain rights in the invention.

### TECHNICAL FIELD

The present disclosure relates to the field of composite objects and to the field of forming 3D structures using 2D sheets or plies.

### BACKGROUND

The ability to transform two-dimensional (2D) sheets into three-dimensional (3D) curved shapes enables a broad range of applications, including camouflage, soft robotics, deployable systems, and biomedical devices.

A number of techniques have been attempted to form 2D sheets into 3D curved shapes. Such techniques often involve cutting and/or folding. Such approaches, however, impose intrinsic Gaussian curvatures into the final shape, leading to conformal 3D surfaces free of overfolds or wrinkles. Further, cutting can weaken the material mechanically. Accordingly, there is a long-felt need in the art for improved approaches for forming 3D objects with 2D sheets.

### SUMMARY

In meeting the described needs, the present disclosure first provides a method of forming a three-dimensional (3-D) target object having a surface, the method comprising: with a cutting graph corresponding to a two-dimensional (2-D) representation of a polyhedral mesh that is representative of the 3-D target object, forming i sheets in conformity with the cutting graph, i being from 1 to n, an i-th 2-D sheet having an i-th set of cuts formed therein, an (i+1)-th 2-D sheet having a (i+1)-th set of cuts formed therein, the (i+1)-th set of cuts optionally differing from the i-th set of cuts, the sets of cuts being arranged in the n 2-D sheets such that when the n 2-D sheets are stacked and consolidated to form the 3-D target object, a minimum number of cuts overlap.

Also provided is a 3-D composite object having a surface, the 3-D composite object comprising: i stacked and consolidated sheets, i being from 1 to n, an i-th sheet having an i-th set of cuts formed therein, an (i+1)-th sheet having a (i+1)-th set of cuts formed therein, the (i+1)-th set of cuts optionally differing from the i-th set of cuts, the sets of cuts being arranged in the n sheets such that when the n sheets are stacked and consolidated to form the 3-D object, a minimum number of cuts overlap.

Further disclosed is a kit for forming a 3-D target object, comprising: i sheets in conformity with the cutting graph, i being from 1 to n, an i-th 2-D sheet having an i-th set of cuts formed therein, an (i+1)-th 2-D sheet having a (i+1)-th set of cuts formed therein, the (i+1)-th set of cuts differing from any other n−1 sets of cuts, the i sheets being formed in accordance with a cutting graph corresponding to a two-dimensional (2-D) representation of a polyhedral mesh that is representative of the 3-D target object.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

In the drawings, which are not necessarily drawn to scale, like numerals may describe similar components in different views. Like numerals having different letter suffixes may represent different instances of similar components. The drawings illustrate generally, by way of example, but not by way of limitation, various aspects discussed in the present document. In the drawings:

FIGS. 1A-1D provide strategies of conforming 2D sheets towards 3D curved surfaces. FIG. 1A, Wrapping a flat sheet around a curved surface results in wrinkles, compromising the mechanical performance of the structure. FIG. 1B, Auxetic kirigami patterns are stretched open to cover the 3D structure without the formation of wrinkles but introduce openings and vulnerable small hinges in-between. FIG. 1C, Computational wrapping algorithm provides full coverage of the curved surface, while the overlapped cuts weaken the mechanical performance of the resulting structure. FIG. 1D, Optimization of the cuts in multilayered plies to avoid cuts at the same position upon stacking, while enhancing strength via shearing among the plies.

FIGS. 2A-2D provide an unfolding approach and optimization procedure of the multi-ply stacking. FIG. 2A, Schematic of unfolding a polyhedral mesh into a 2D net to conform a prescribed 3D curved surface. FIG. 2B, Optimization procedure to avoid cuts overlapped at the same positions. The cut edges of each ply are mutually exclusive from those of other plies by mutating the weights of the cutting graph. FIG. 2C, Stacking of four optimized plies without cut overlapping. The existence of cuts is ignored where the tabs are introduced. FIG. 2D, Comparison of the number of overlapped cuts from the random design, and the optimized designs with and without tabs. Each design consists of eight plies.

FIGS. 3A-3E provide experimental validation for 2D and 3D structures with different layups. FIG. 3A provides 2D specimens of different cut distributions. Each specimen consists of 8 plies with each ply containing a cut with its position varied from ply to ply. S6-2 denotes 6 and 2 cuts overlapped at two positions, respectively. The same notion applies to others and the distance between cuts is L=25 mm. FIG. 3B, Experimental stress-strain curves for the dog bone specimens under uniaxial tensile tests and FIG. 3C load-deflection curves for the rectangular specimens under three-point bend tests. The color of each line corresponds to that shown in FIG. 3A. Error bars indicate the standard deviation for the measurements. FIG. 3D, Experimental snapshots of a cut ply and a consolidated hemisphere with the optimized layup fabricated from Tensylon HSBD30A. Scale bar=20 mm. FIG. 3E, Load-displacement curves of the hemispherical samples under compression.

FIGS. 4A-4E illustrate the generality of our model to non-convex surfaces. FIG. 4A, A face guard with both positive and negative Gaussian curvatures. FIG. 4B, Overlap can not be avoided in a single patch of the unfolded net due to the existence of hyperbolic vertices. FIG. 4C, Unfolding for the hyperbolic vertex leads to θₕ>2π and a self-overlapped net, while unfolding for the ellipsoidal vertex results in θₑ<2π and a overlap-free net. FIG. 4D, Optimized plies for the face guard with each ply comprising two patches. FIG. 4E, Experimental snapshot of the consolidated face guard fabricated from Tensylon HSBD30A. Scale bar=20 mm.

FIGS. 5A-5C provide experimental snapshots of 2D specimens. FIG. 5A, Slits are cut in the plies to introduce the discontinuities in the samples. FIG. 5B, slits are marked to verify the alignment of the plies. FIG. 5C, Samples are cut out of the consolidated panels using a waterjet.

FIGS. 6A-6C provide a schematic of the fabrication for 2D specimens. FIG. 6A, plies are stacked together with prescribed slit alignment. FIG. 6B, the stacked plies are consolidated in a press with a normal pressure of 20.7 MPa and a temperature of 110° C. FIG. 6C, samples with prescribed geometries are cut from the correct positions of the panel.

FIGS. 7A-7B provide consolidation conditions for (FIG. 7A) 2D specimens and (FIG. 7B) 3D curved structures.

FIGS. 8A-8F illustrate fabrication of the 3D curved structures. Snapshots of the 6 steps required to fabricate the structures.

FIGS. 9A-9F provide experimental stress-strain curves for dog bone specimens with different layups. Error bars indicate the standard deviation (STD) for the measurements.

FIGS. 10A-10F provide three-point bending curves for rectangular specimens with different layups. Error bars indicate the STD for the measurements.

FIG. 11 illustrates an example design of the tabs. The tabs of the plies are trimmed from the corresponding triangular facets of the cut edges with a minimum width wtag (see tabs i and j and their corresponding facets it and jt). Tabs are invalid and will not be kept if they overlap with the triangular facets or other tabs (see tabs with red color).

FIG. 12. provides a flow chart of an optimization procedure.

FIGS. 13A-13C provide an optimized design for a semi-ellipsoidal surface.

FIGS. 14A-14C provide an optimized design for a helmet.

FIGS. 15A-15C provide an optimized design for a racing car seat.

FIG. 16 illustrates discretizing a smooth surface using different meshes. The edges of these two meshes are mutually orthogonal with each other. Plies generated from these two meshes are free of overlapping on cuts.

### DETAILED DESCRIPTION OF ILLUSTRATIVE EMBODIMENTS

The present disclosure may be understood more readily by reference to the following detailed description of desired embodiments and the examples included therein.

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent to those described herein can be used in practice or testing. All publications, patent applications, patents and other references mentioned herein are incorporated by reference in their entirety. The materials, methods, and examples disclosed herein are illustrative only and not intended to be limiting.

The singular forms “a,” “an,” and “the” include plural referents unless the context clearly dictates otherwise.

As used in the specification and in the claims, the term “comprising” may include the embodiments “consisting of” and “consisting essentially of” The terms “comprise(s),” “include(s),” “having,” “has,” “can,” “contain(s),” and variants thereof, as used herein, are intended to be open-ended transitional phrases, terms, or words that require the presence of the named ingredients/steps and permit the presence of other ingredients/steps. However, such description should be construed as also describing compositions or processes as “consisting of” and “consisting essentially of” the enumerated ingredients/steps, which allows the presence of only the named ingredients/steps, along with any impurities that might result therefrom, and excludes other ingredients/steps.

As used herein, the terms “about” and “at or about” mean that the amount or value in question can be the value designated some other value approximately or about the same. It is generally understood, as used herein, that it is the nominal value indicated ±10% variation unless otherwise indicated or inferred. The term is intended to convey that similar values promote equivalent results or effects recited in the claims. That is, it is understood that amounts, sizes, formulations, parameters, and other quantities and characteristics are not and need not be exact, but can be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. It is understood that where “about” is used before a quantitative value, the parameter

Unless indicated to the contrary, the numerical values should be understood to include numerical values which are the same when reduced to the same number of significant figures and numerical values which differ from the stated value by less than the experimental error of conventional measurement technique of the type described in the present application to determine the value.

All ranges disclosed herein are inclusive of the recited endpoint and independently of the endpoints (e.g., “between 2 grams and 10 grams, and all the intermediate values includes 2 grams, 10 grams, and all intermediate values”). The endpoints of the ranges and any values disclosed herein are not limited to the precise range or value; they are sufficiently imprecise to include values approximating these ranges and/or values. All ranges are combinable.

As used herein, approximating language may be applied to modify any quantitative representation that may vary without resulting in a change in the basic function to which it is related. Accordingly, a value modified by a term or terms, such as “about” and “substantially,” may not be limited to the precise value specified, in some cases. In at least some instances, the approximating language may correspond to the precision of an instrument for measuring the value. The modifier “about” should also be considered as disclosing the range defined by the absolute values of the two endpoints. For example, the expression “from about 2 to about 4” also discloses the range “from 2 to 4.” The term “about” may refer to plus or minus 10% of the indicated number. For example, “about 10%” may indicate a range of 9% to 11%, and “about 1” may mean from 0.9-1.1. Other meanings of “about” may be apparent from the context, such as rounding off, so, for example “about 1” may also mean from 0.5 to 1.4. Further, the term “comprising” should be understood as having its open-ended meaning of “including,” but the term also includes the closed meaning of the term “consisting.” For example, a composition that comprises components A and B may be a composition that includes A, B, and other components, but may also be a composition made of A and B only. Any documents cited herein are incorporated by reference in their entireties for any and all purposes.

The ability to transform two-dimensional (2D) sheets into three-dimensional (3D) curved shapes enables a broad range of applications, including camouflage, soft robotics, deployable systems, biomedical devices, structures, and protection devices.

Among different techniques, kirigami that involves both cutting and folding imposes intrinsic Gaussian curvatures into the final shape, leading to conformal 3D surfaces free of overfolds or wrinkles. However, cutting typically weakens the material mechanically. Here, we report an optimal cutting approach that transforms composite cross-plies (the preform) into 3D doubly-curved laminates with optimized mechanical properties. Guided by numerical modeling, the multilayered preform can transform into desired 3D shapes with minimum cuts overlapped at the same position.

After consolidation, the weakness induced by cuts can be mitigated by the shearing forces between the plies. Our approach opens a fundamentally new paradigm to conform complex shapes of arbitrary curvatures while offering control over the local reinforcement architecture for light-weight yet high mechanical strength.

To realize shape morphing and complex curvature conforming of flat sheets, two strategies have been commonly pursued. One is to introduce inhomogeneous in-plane strains in soft elastomers via pneumatic inflation, swelling, application of electric fields and thermal activation. The other exploits kirigami and origami engineering to program the Gaussian curvatures from inextensible flat sheets. However, both approaches fail to produce 3D geometries that are both lightweight and mechanically strong as a result of stretchability, cutting and folding.

Laminated composite and hybrid materials, which are constructed from preforms consisting of layers of either high-performance fibers or minimally shear deformable films, have been extensively used in the aerospace and automotive industries, sports products and medical equipment, where the properties such as light-weight, high mechanical strength and stiffness are essential. The technology for manufacturing these materials into flat and singly curved structures is well developed. However, to achieve complex curved shapes, the necessary local deformation in the anisotropic materials often results in either shear failure, wrinkling, or significant changes in local reinforcement architecture, all of which severely limit the performance of the resulting structure.

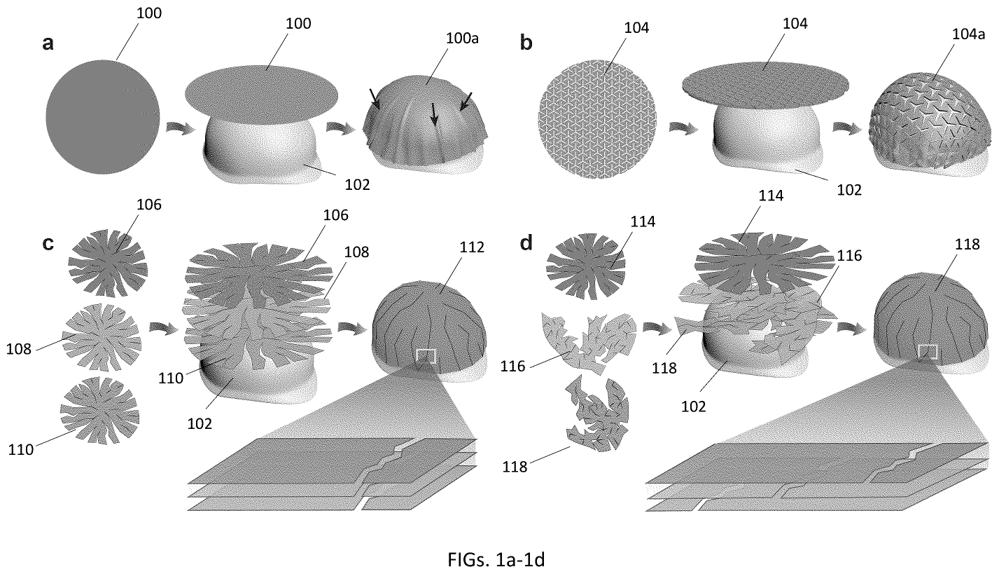

As shown in FIG. 1A, wrinkles and crumples will form when conforming a flat sheet 100 to a hemisphere 102. Conventionally, flat plies can be “cut and darted” in order to better conform to the desired shape, but this process has been highly empirical with little control of layup architecture. Thermoforming techniques have also been used to preform composite plies into the desired shape prior to consolidation under heated compaction. This approach is restricted to shear deformable materials and will result in non-uniform thicknesses due to inhomogeneous material shear gradients (shear deformation causes local material thickening) and wrinkles in the resulting structure where shear deformation is not sufficient for the material to conform to the final shape.

Recent advancement in mechanical metamaterials (e.g., kirigami) provides new strategies in programming curvature by introducing cuts into a planar sheet (shown as 104 in FIG. 1B), an approach enabling the deployment of non-periodic tessellations to conform approximately to any prescribed 3D target shapes. However, the small hinges and uncovered regions of these tessellations are detrimental to the mechanical properties of the entire structure (element 104a in FIG. 1B). Alternatively, as shown in FIG. 1C, the computer graphics community segments a non-developable surface into developable polyhedral nets (106, 108, and 110) via algorithmically determined surface cuts, allowing for full coverage of the desired 3D surfaces (102) without empty space (112). However, the unoptimized cuts overlap at the same positions, severely compromising the in-plane strength (element 112 in FIG. 1C).

To circumvent the weakness induced by the cuts, we develop, as shown in FIG. 1D, a universal approach to optimize the mechanical properties of the prescribed 3D structures by rationalizing the cuts in the 2D nets.

For a given curved surface, we calculate multiple pathways to cut and unfold the discretized surface to valid 2D nets (114, 116, and 118) without self-overlapping. We then optimize the pathways to minimize the number of overlapped cuts at the same position when stacking the multilayered preform plies (118). After consolidating the folded composite plies, load sharing among plies via interlaminar shear can mitigate the effect of cuts, providing additional strength to the structure.

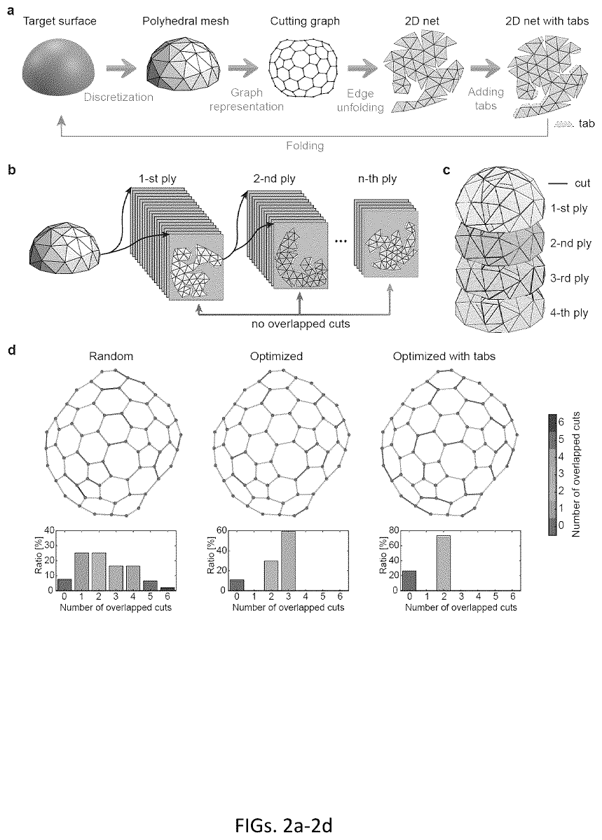

Our approach is validated by quasi-static mechanical testing of multiple 2D and 3D specimens with (or without) the optimized layups. The optimized specimens show significant improvement in mechanical performance compared to those without optimization, including more than 2 times increase in the tensile strength for 2D specimens and around 40% increase in the compression peak force for the hemispherical shells. First, we unfold the curved surface to valid 2D nets without self-overlapping. For a given target surface, we approximate the smooth surface using a polyhedral mesh comprising triangular facets with appropriate dimensions (FIG. 2A).

While discretizing the surface with finer facets results in better smoothness and conformability to the target surface, it will also increase the computational expense for optimization and compromise the mechanical performance since more cuts have to be introduced. In our study, we use N∈[50, 100] triangular facets to approximate the prescribed surface to obtain good conformability, reasonable computational cost and high mechanical strength. Then, we represent the polyhedral mesh using a cutting graph and employ this graph to unfold the mesh to 2D nets by calculating its minimum spanning tree (MST) using the Prim's algorithm.

Since the cutting graph elucidates the connection of the facets for the polyhedral mesh (i.e., the vertices and edges of the cutting graph correspond to the facets and edges of the mesh, respectively), the partition pathway of the polyhedral mesh can be determined by the MST of the cutting graph. For instance, by assigning a set of weights to the edges of the cutting graph, we can obtain a unique MST to specify the cutting pathway, where the edges will be cut if they do not belong to the MST.

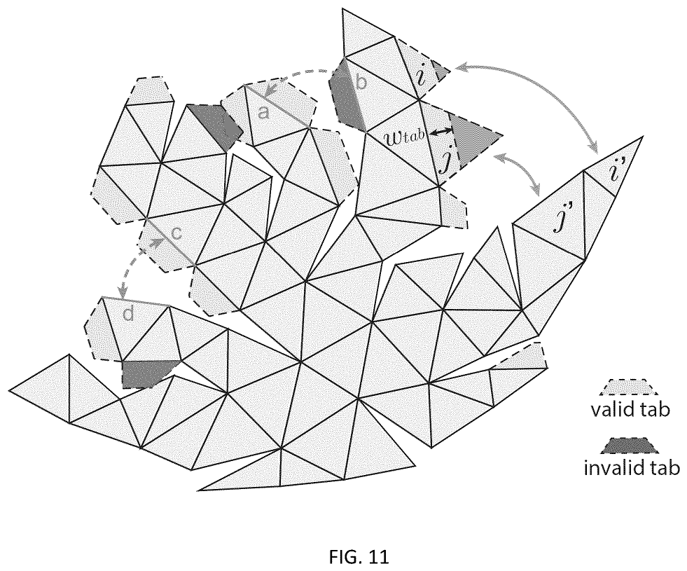

However, the unfolding net is typically not a valid net containing multiple overlaps. To obtain a valid net without any overlap, we check if any facets of the nets are intersected with each other. Moreover, to minimize the effect of cuts on the mechanical performance of the folded composite structure, we add tabs to the cut edges of the net if no new overlap is introduced by the tabs (see design of the tab in FIG. 11). Hence after the folded plies are consolidated, load transfer through the interlaminar shear stress between the additional tabs and the corresponding facets provides extra in-plane strength to the cut edges, which is known as the shear lag effect.

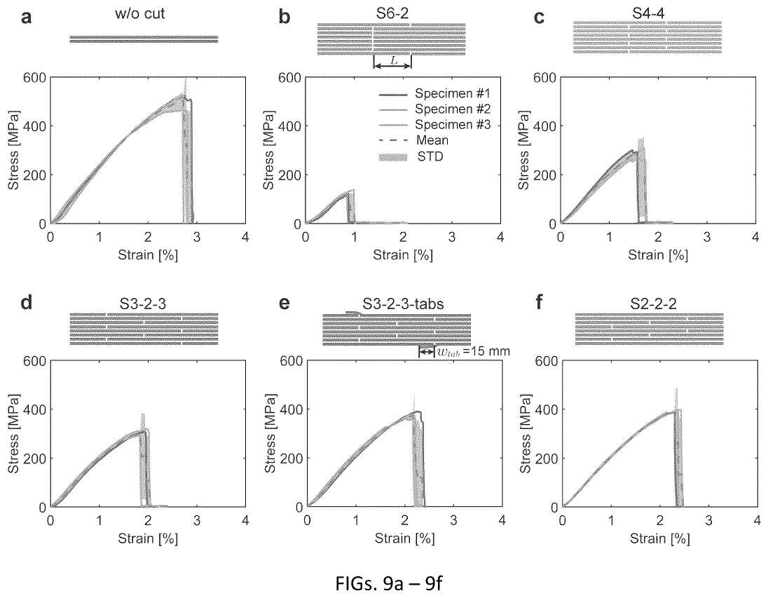

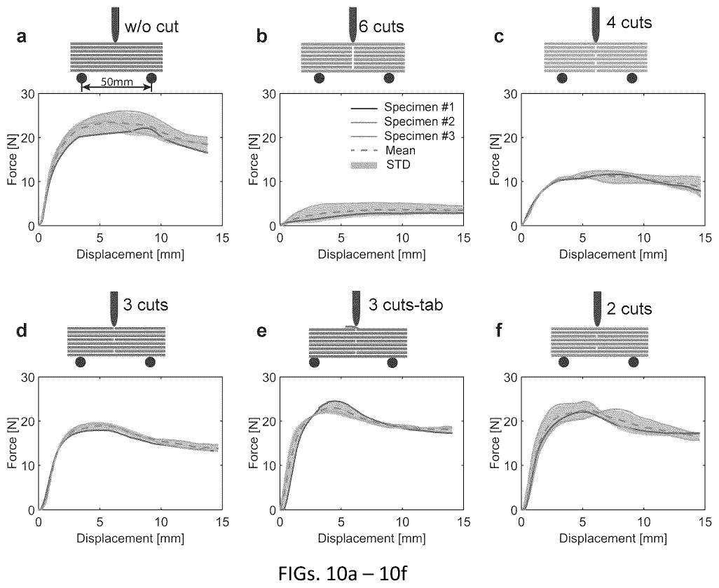

Our experiments show that when the tab width is large enough (i.e. W_{tab}≥15 mm, for the composite material considered here), the in-plane strength will not be compromised regardless of the presence of the cuts (see experimental validations in FIGS. 9A-9F and FIGS. 10A-10F).

To produce a 3D curved structure with high mechanical strength, multiple plies are typically stacked and consolidated. However, wrapping several nets with the same geometries gives rise to repeated cuts at the same location, which severely reduces the strength of the resulting structure (FIG. 1C).

To tackle this issue, we exploit load sharing by interlaminar shear among the consolidated plies and propose a universal optimization approach to guide the cutting pathway of each ply to minimize the number of overlapped cuts (FIG. 2B). Specifically, for a simple polyhedral mesh we can find multiple cutting pathways producing valid 2D nets without self-overlapping. We randomly choose one from these nets as one of the optimized plies. For the next ply, we calculate the cutting pathway such that it is mutually exclusive on the cuts from the previous ply(s) by mutating the weights of the cutting graph. We reiterate this procedure until the maximum number of optimized plies nₘₐₓ is achieved, where no cuts overlap at the same position.

As a result, the edges of the polyhedral mesh (Eₘₑₛₕ) and the cut edges of the i-th optimized ply (E) have the following relationships

E₁∪E₂∪ . . . ∪Eₙ_{ₘₐₓ}⊆Eₘₑₛₕ, (1)

Eᵢ∩Eⱼ=Ø,i,j=1,2, . . . ,nₘₐₓ and i≠j. (2)

The maximum number of optimized plies, nₘₐₓ, is determined by the number of the edges for the polyhedral mesh n_{edge} and the number of cuts in each ply n_{cut} through

nₘₐₓ=└n_{edge}/n_{cut}┘, (3)

where the floor function └x┘ outputs the greatest integer less than or equal to x. For instance, the hemispherical mesh shown in FIG. 2B has 65 triangular facets, n_{edge}=91 edges and 27 cycles in its cutting graph. To unfold the mesh to a 2D net, n_{cut}=27 cuts are necessary. According to Eq. 3, the maximum number of optimized plies for this hemispherical mesh is nₘₐₓ=3. Namely, the optimized cuts will not repeat at the same position in a three ply layup. For a structure comprising more than three plies, the optimized plies can be repeated until reaching the target thickness.

Moreover, nₘₐₓ can be increased when additional tabs are added to the cut edges to further mitigate the mechanical weakness induced by the cuts. Here, we assume that the cut can be ignored where a tab with large enough dimension is added. For the hemispherical mesh shown in FIG. 2B, the number of cuts (n_{cut}) can be reduced from 27 to between 17 and 23 for the design with tabs, and the specific number is determined by the geometry of the net which affects the number of tabs that can be introduced to the net. Therefore, nₘₐₓ=4 can be achieved for the optimized design with tabs, resulting in the structure without cut overlapping at the same position in a four ply layup.

The optimized plies of the hemispherical mesh are demonstrated in FIG. 2C, the cuts and tabs are highlighted with red lines and yellow patches, respectively. Since no cut overlaps at the same position among the four plies, the cuts are homogeneously distributed in the entire structure.

To quantify the effectiveness of our model, we compare the number of overlapped cuts at each edge of the hemispherical mesh for three different designs in FIG. 2D, including the random design, the optimized design, and the optimized design with tabs. Each design comprises 8 plies.

The bar charts in FIG. 2D illustrates the ratio of the number of overlapped cuts to the total number of edges n_{edge} in the mesh. In the case with random design, each ply is generated by assigning random weights to the cutting graph of the hemispherical mesh; up to 6 cuts are found overlapped at some edges. The maximum number of overlapped cuts is reduced to 3 for the optimized design. Since the optimized design with tabs repeats the cuts in every four plies, the maximum of cuts overlapped at the same position is reduced to 2, clearly demonstrating the effectiveness of our model.

The principle of our approach is to optimize the cut distribution in a multi-ply stacked composite structure with minimum compromise on the mechanical strength of the structure. The in-plane strength of the laminated plies is crucial to the mechanical performance of the resulting 3D curved structures. However, it is challenging to characterize the effect of cut distribution on the in-plane properties of 3D curved structures directly.

To validate the effectiveness of our approach for different structures, we fabricate both 2D and 3D specimens and characterize their mechanical responses under different loading conditions. All samples are fabricated from Tensylon HSBD30A (DuPont™), a high modulus bidirectional laminate made from ultrahigh molecular weight polyethylene (UHMWPE) with two orthogonal layers of solid-state extruded films coated with adhesives. The material has ply thickness t=155 μm, in-plane shear modulus G₁₂=1.5 GPa, axial tensile modulus E₁₁=E₂₂=44 GPa.

Compared to fiber-based materials solid-state extruded films such as Tensylon have much higher in-plane shear stiffness and can only undergo a few degrees of in-plane shear prior to failure, therefore they cannot easily be thermoformed into a hemisphere without wrinkling or tearing.

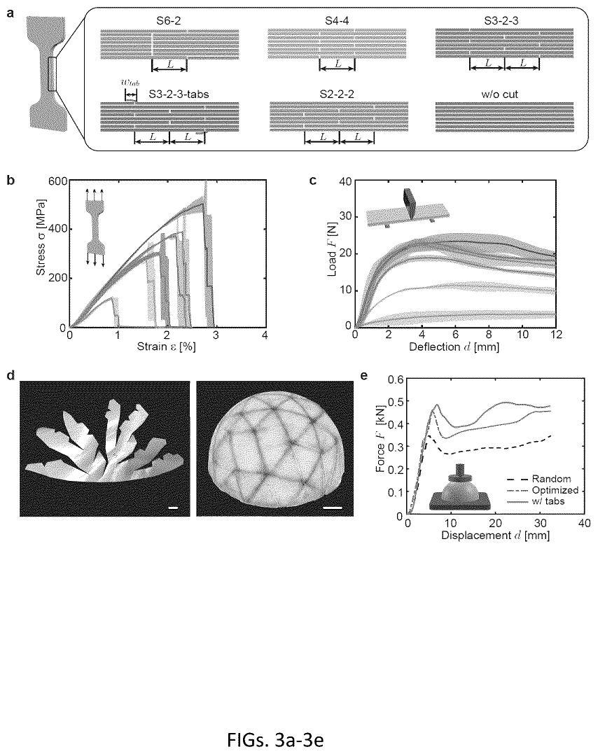

First, we conduct uniaxial tensile tests for dog bone specimens with different layups of cuts (FIG. 3A). Each specimen consists of eight plies with a through-cut in each ply. By changing the position of the cuts in the plies, we can mutate the number of overlapped cuts at different positions.

As seen in (FIG. 3A), we design five sets of specimens. The first (denoted as S6-2) has 6 and 2 cuts overlapped at two positions, respectively, with the distance of L=25 mm between the cuts. Assuming that the 25 mm overlap is enough to recover the full strength of a single cut, we expect the tensile strength of this specimen is around a quarter of the specimen without any cut, since the weakest position of the specimen has only two plies connected among the eight plies.

To enhance the strength of the specimens we evenly distribute the cuts between the two positions, obtaining the S4-4 specimen, which redistributes the in-plane load across each cut with 25 mm overlap between the adjacent plies and is expected to have half the tensile strength of the specimens without any cuts. Similarly, if the cuts are arranged at three positions, the resulting specimen (S3-2-3) is expected to have up to ⅝ of the tensile strength of the pristine specimen without any cuts. We can further increase the strength of the specimens by introducing tabs (see S3-2-3-tabs specimen in FIG. 3A). After consolidation, the shear forces between the tabs and the adjacent plies can provide additional strength to the specimens.

To evaluate the effect of the tabs on the mechanical properties of the specimens, we compare the S3-2-3-tabs specimen, which has a tab on the top and at the bottom ply, respectively, with the S2-2-2 specimen, which has only two cuts at each position and no cut in the top and bottom plies. When the width of the tabs is large enough, the S3-2-3-tabs and S2-2-2 samples should have similar tensile strength. The specimen without cuts is tested as a reference.

In FIG. 3B, the stress-strain curves of the dog bone specimens under uniaxial tensile loading is in full agreement with our assumptions, that is the S6-2 specimens have the smallest mean strength (average strength of three specimens) with σ₆₋₂=119 MPa, a 76% reduction in strength compared to the specimens without a cut (σ_{w/o cut}=503 MPa). As expected S4-4 and S3-2-3, the specimens with homogenized cut distributions (where cuts are not at the same location in consecutive plies) have a higher strength than the S6-2 specimens (which have cuts at the same location in 6 consecutive plies), with σ₄₋₄=281 MPa and σ₃₋₂₋₃=302 MPa. The strength of the specimens with tabs (σ_{3-2-3-tabs}=372 MPa, with w_{tab}=15 mm) is significantly enhanced relative to the S3-2-3 specimen and similar to the strength of the specimens without cuts in the top and bottom plies (σ₂₋₂₋₂=390 MPa), validating the effectiveness of tabs in our optimization model.

To characterize the cut distribution on bending properties of the specimens, we then compare the load-deflection curves of the three-point bend tests for rectangular samples sharing the same cut distribution with the dog bone samples in FIG. 3C. A trend similar to that observed in the tensile tests is also seen in the bending behavior, that is both (i) homogenizing the cut distribution and (ii) adding the tabs can enhance the mechanical strength of the structures, indicating that our optimization approach is valid for different types of loads.

We now move to validate the optimized hemispherical structure. Three hemispherical specimens are manufactured according to the designs shown in FIG. 2D. FIG. 3D shows the experimental snapshots of a single cut ply and a processed hemisphere with the optimized layup, showing complete conformal coverage of the multi-stacked plies to the entire hemisphere.

It is noted that there are no wrinkles in the hemisphere, confirming that the triangular facet size selected is not too large. Then, we conduct the compression tests (loading on top of the hemisphere) and the resultant force is reported as a function of the applied displacement in FIG. 3E.

All curves show a linear regime followed by a load drop before further stiffening, and the peak force of the optimized specimen F_{optimized} is remarkably larger than that of the random design, characterized by F_{optimized}=1.31F_{random}. The optimized specimen with tabs has a even larger peak force with F_{tabs}=1.40F_{random}, confirming that including tabs in our model improves the mechanical strength of the resulting structures.

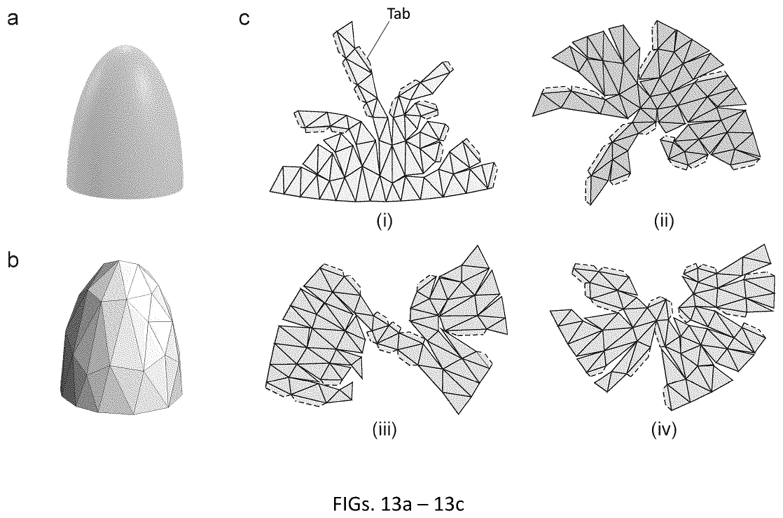

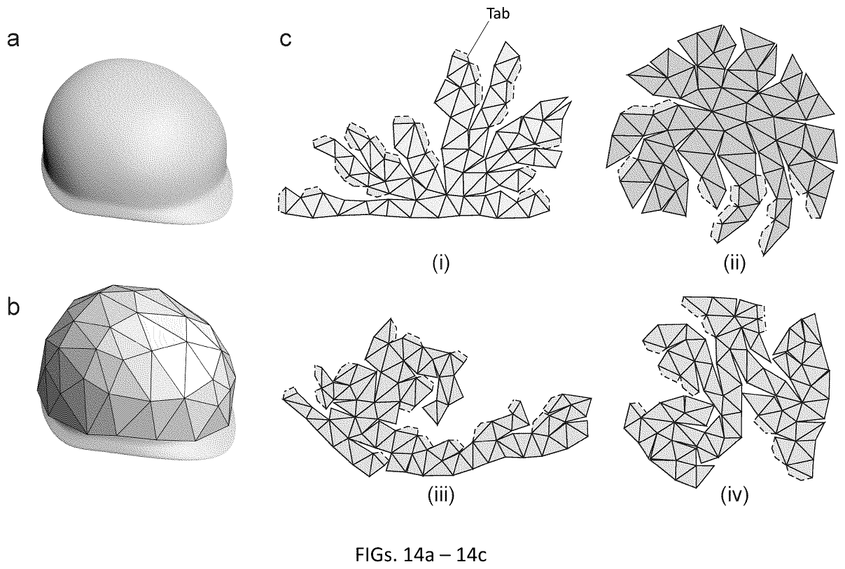

Armed with the confidence of our optimized model in conforming hemispherical structures using non-shear deformable laminated plies, we extend our model to various curved surfaces to demonstrate its universality. For the convex surfaces with only positive Gaussian curvature, we can optimize the cutting pathways for non-developable surfaces to unfold them into a couple of single-patch 2D nets, which when folded to the prescribed 3D surfaces have minimal overlapped cuts at the same position (e.g. the hemisphere in FIGS. 2A-2C, the semi-ellipsoid in FIGS. 13A-13C, and the helmet in FIGS. 14A-14C).

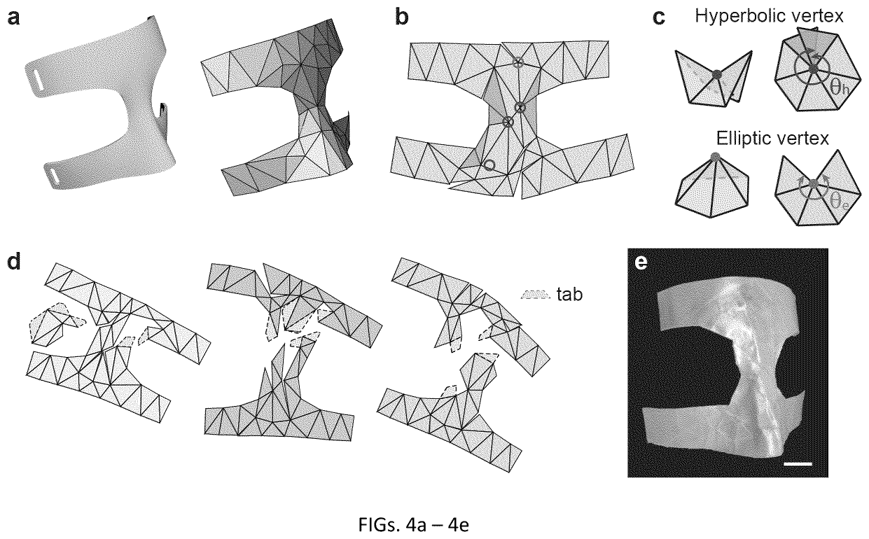

However, there are many examples of non-convex polyhedral meshes that do not have a valid unfolding within a single patch, owing to the existence of negative Gaussian curvatures. For example, a face guard, where light-weight and high strength are essential to protect the face from full-contact impact, has both positive and negative Gaussian curvatures (see FIG. 4A).

Unfolding this kind of surface typically results in 2D nets with local self-overlaps (see the red facets shown in FIG. 4B). This is because the surfaces with negative Gaussian curvatures contain hyperbolic vertices, and the sum of the adjacent facets' angles for each hyperbolic vertex θₕ is larger than 2π. Therefore, at least two cuts have to be introduced for the hyperbolic vertex to avoid local overlaps, whereas for the elliptic vertex, one cut is enough to avoid local overlaps as θₑ<2π (FIG. 4C).

Although a few algorithms have been developed to unfold non-convex polyhedral meshes into a single patch and such algorithms can be easily integrated into our model, the additional constraint of minimizing cut overlaps hinders us from finding valid nets in a single connected patch for non-convex polyhedral surfaces.

To enhance the capability and efficiency of our model on handling structures with arbitrary curvatures, we introduce additional cuts for the non-convex surfaces to avoid the self-overlaps induced by the hyperbolic vertices. We note that the additional cuts will segment the 2D net into several patches, weakening the structure. To eliminate this weakness, we minimize the number of additional cuts by employing the greedy algorithm and add tabs to the additional cuts to enhance the mechanical performance of the structure.

Accordingly, an optimized design for a nearly arbitrary curved structure is realized. For the face guard shown in FIG. 4A, it yields three optimized plies with each ply comprising two patches (FIG. 4D) and without overlapped cuts. FIG. 4E is a photograph of an experimental face guard after folding and consolidating from Tensylon HSBD30A plies, the design seen in FIG. 4A.

In summary, we have introduced a universal optimization approach to morph flat composite plies towards prescribed 3D curved surfaces with optimal mechanical performance. Our algorithms minimize the number of overlapped cuts at the same position and introduce additional tabs for the applicable edges, resulting homogeneously distributed cuts in the multi-ply stacked structures.

Through 2D and 3D mechanical testing under different load conditions, we have demonstrated the validity of our approach on improving the mechanical performance of the structures by optimizing their layups. Our model is universal to a variety of curved structures and can accommodate all the existing algorithms for unfolding polyhedral meshes. The disclosed methods can be used with a variety of meshes; for instance, one can approximate the target surface using the combination of two different meshes whose edges are mutually orthogonal with each other.

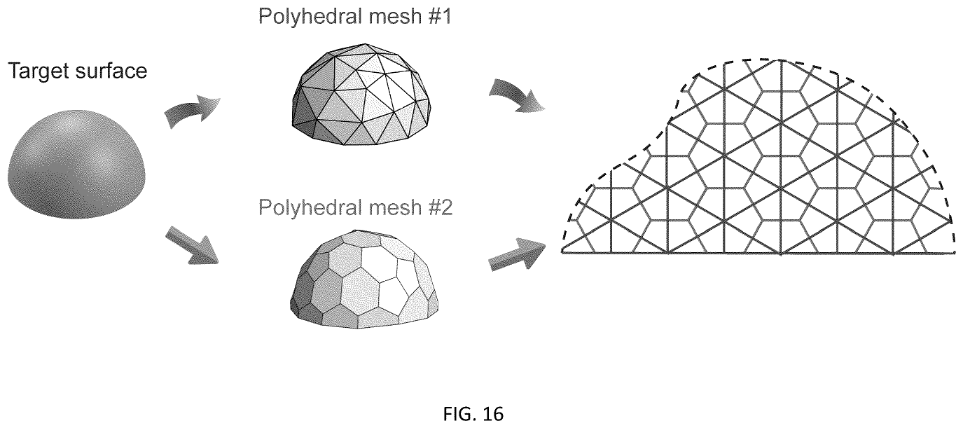

By stacking the optimized designs from these meshes, the number of plies without overlapped cut can be further increased (see FIG. 16). However, it should be noticed that the orientation of each composite ply (with orthotropic mechanical properties) has not been optimized in our model, since the cut distribution is more dominant on the mechanical performance than the orientation of the orthotropic plies. As such, the algorithms disclosed in this work guide the design of diverse composite structures with curved geometries which require light-weight and high mechanical performance, and open up a new paradigm for the design of next-generation composite structures whose shapes are preserved with minimal compromise on mechanical strength.

Additional Disclosure

Fabrication

All structures investigated in this study are fabricated from Tensylon HSBD30A plies (DuPont™) with thickness t=155 μm, in-plane shear modulus G₁₂=1.5 GPa, axial tensile modulus E₁₁=E₂₂=44 GPa and in-plane Poisson's ratio V12=0.01. The Tensylon ply is comprised of cross-plied [0/90] solid state extruded Ultra-high-molecular-weight polyethylene (UHMWPE) films with a polyolefin matrix/adhesive on one side of the film.

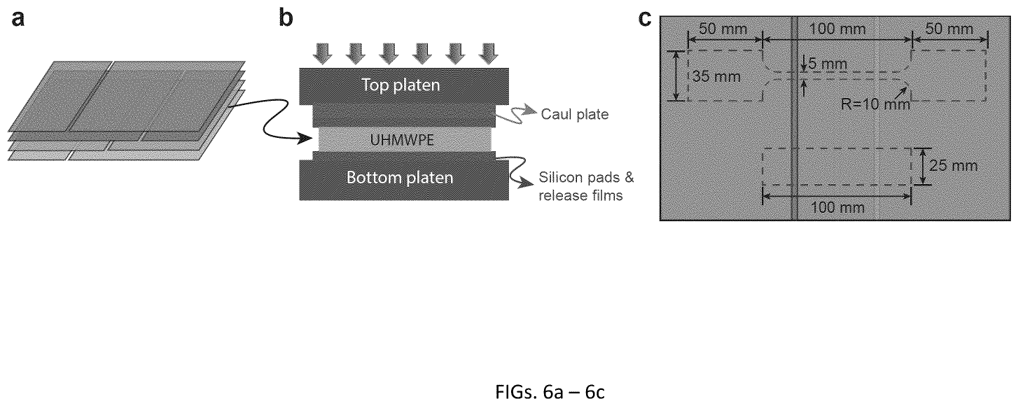

2D specimens. We fabricate 2 types of 2D specimens with different cut distribution (i.e., the dog bone specimens and the rectangular specimens, see their geometric parameters in FIG. 6C and FIG. 3A) and characterize their in-plane strength via uniaxial tensile tests and bending properties using three-point bending tests. Each specimen is comprised of 8 plies with each ply having one cut, except for the S2-2-2 specimens which have no cuts in the top and the bottom plies and the w/o cut specimens which have no cuts in all plies. To investigate the effect of cut distribution on the mechanical performance of the specimens, we mutate the number of overlapped cuts in the specimen by changing the position of the cut for each ply. See the geometric details of each specimen in Table 1.

TABLE 1
Geometric descriptions defining the layup of 2D specimens.
All parameters are defined in FIG. 3A, the distance
between adjacent cuts is L = 25 mm.

| Category | Descriptions |
|---|---|
| S6-2 | The cuts are distributed at two positions which |
| | have 6 and 2 over-lapped cuts, respectively. |
| S4-4 | The cuts are evenly distributed at two positions |
| | with each one having 4 overlapped cuts. |
| S3-2-3 | The cuts are arranged at three positions which have |
| | 3, 2 and 3 cuts overlapped, respectively. |
| S3-2-3-tabs | This specimen is similar to S3-2-3, with the exception |
| | of an additional tab (l = 15 mm) at the positions |
| | containing 3 overlapped cuts. |
| S2-2-2 | This specimen has 6 cuts evenly distributed at 3 positions |
| | with 2 overlapped cuts at each position. The top and bottom |
| | plies have no cuts. |
| w/o cut | No cuts are introduced in this specimen. |
| | To avoid slip and delamination at the grips in tensile tests, |
| | the dog bone sample is limited to 2 plies thick (3). |
| | Bending tests use a rectangular sample comprised |
| | of 8 plies. |

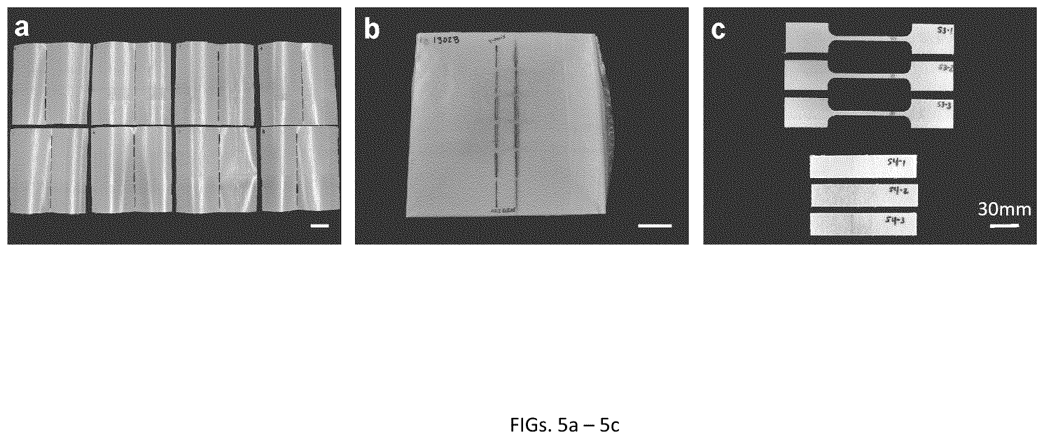

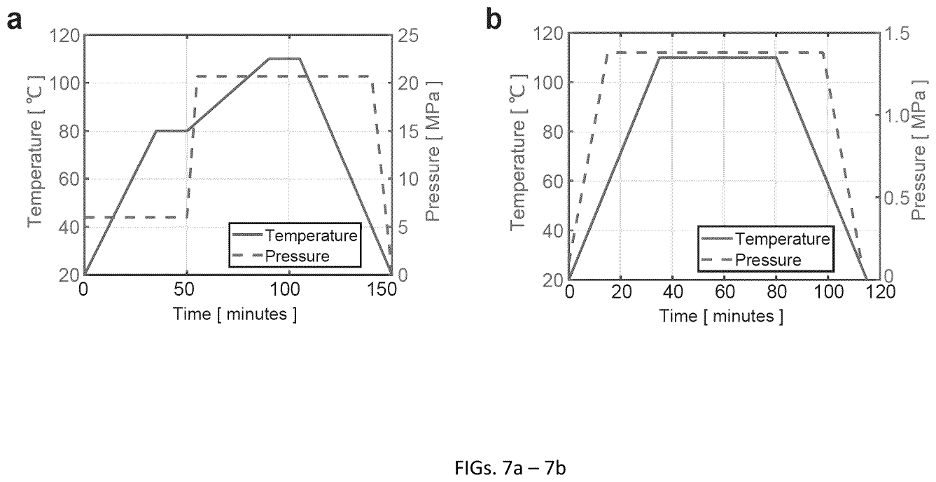

To fabricate the 2D samples, one can employ the following steps:
Step a: Cut the plies with embedded slit patterns using a Gerber cutting table. The slit locations correspond to discontinuities in the samples (FIG. 5A).
Step b: Mark the slits using a permanent marker to verify sheet alignment and ensure samples are cut from the correct locations (FIG. 5B).
Step c: Stack the plies (FIG. 6a) and consolidate them in a Wabash 800-ton (7.1 MN) press with a normal pressure of 20.7 MPa and a temperature of 110° C. (FIG. 6B). The complete high pressure, high temperature consolidation curves are given in FIG. 7A.
Step d: Cut the samples out of the manufactured panels using a waterjet (FIG. 5C and FIG. 6C).

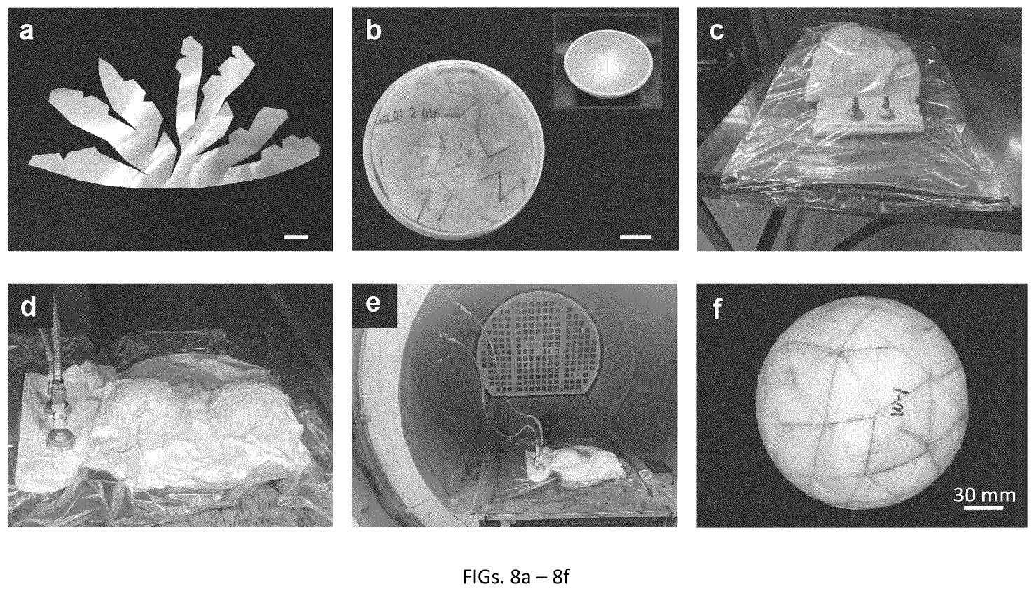

3D curved structures. To fabricate the 3D curved structures with optimized mechanical performance, one can first optimize the geometries of the 2D plies and then process the plies using the following steps:
Step a: Cut plies with the optimized geometries using a laser cutter (FIG. 8A).
Step b: Stack the plies into a 3D mold with the target geometry (FIG. 8B). Mark the facets of each ply to verify the alignment and apply tapes to the top and bottom plies to facilitate the stacking.
Step c: Wrap release films around the mold before putting them into a vacuum bag(FIG. 8C).
Step d: Vacuum the bag and ensure the alignment of the plies is not changed during the vacuum process (FIG. 8D).
Step e: Consolidate the plies in the autoclave under pressure of 1.38 MPa at 110° C. (FIG. 8E). The conditions of the consolidation processes are given in FIG. 7B.
Step f: Remove the consolidated structure from the mold (FIG. 8F).

### Illustrative Experiments

The following experimental results are illustrative only and do not limit the present disclosure or the appended claims.

All mechanical testing was performed using a universal testing machine (Instron 6800 series) equipped with a 2000N load cell for the tensile and compression tests and with a 100N load cell for the bending tests. The tests were performed under displacement control at a rate of 0.05 mm/s for the tensile tests, and 0.2 mm/s for compression and bending tests, respectively.

Uniaxial tensile tests. The uniaxial tensile tests for dog bone specimens with different cut distributions are reported in FIGS. 9A-9C. The results shown in FIG. 9B, FIG. 9C and FIG. 9D indicate that the cut distribution has a significant effect on the tensile strength of the specimens. Although the specimens S6-2, S4-4 and S3-2-3 have the same density of cuts, the S3-2-3 specimens show higher strength than the other two specimens proving the effectiveness of the optimization cut distribution. Moreover, the higher strength of S3-2-3-tabs specimens than that of S3-2-3 specimens (shown in FIG. 9D and FIG. 9E) validates the enhancement of the mechanical strength provided by the tabs. The similar strength of the specimens shown in FIG. 9E and FIG. 9F also indicates that the tabs can eliminate the strength reduction resulting from a cuts, provided the width of the tabs is large enough. The mean strength for the dog bone specimens with different layups is reported in Table 2. To better demonstrate the effect of cut distribution on the tensile strength, we also report specimen strength normalized by the strength of specimen F2.

Three-point bending tests. The resultant force of three-point bending tests for the laminated plies is sensitive to the relative position of the loading pin to the cuts in the specimens.

TABLE 2
Tensile strength of dog bone specimens with different layups.

| | F2 | S6-2 | S4-4 | S3-2-3 | S3-2-3 tab | S2-2-2 |
|---|---|---|---|---|---|---|
| Strength | 502.56 | 119.25 | 281.02 | 301.55 | 372.26 | 389.51 |
| (mean) | | | | | | |
| [MPa] | | | | | | |
| Normalized | 1 | 0.237 | 0.559 | 0.600 | 0.741 | 0.775 |
| strength | | | | | | |

Hence, we arrange the cuts just under the loading pin in our tests and set the distance between the supporting pins to be 50 mm (see schematic in FIGS. 10A-10F). From the load-deflection curves reported in FIGS. 10A-10F, we can see that the cut distribution has a significant effect on the mechanical response of the specimens and the peak forces decreases as the number of overlapped cuts increase. This trend is similar to that of the tensile testing, which validates the effectiveness of our approach on i) homogenizing the cut distribution and ii) mitigation of the cut by adding tabs. The absolute and normalized peak forces for the rectangular specimens with different layups are reported in Table 3.

Compression tests for the hemispheres. To validate that the optimized 3D curved structure has better mechanical performance than the one with randomly designed cut distribution, we conduct compression tests on the hemispherical specimens with different layups (i.e., the random design, the optimized design and the optimized one with tabs). The force-displacement curves of these samples are reported in FIG. 3E.

TABLE 3
Peak forces of the rectangular specimens with different layups.

| | no cut | 6 cuts | 4 cuts | 3 cuts | 3 cuts-tab | 2 cuts |
|---|---|---|---|---|---|---|
| Peak force | 23.39 | 3.63 | 11.45 | 18.92 | 22.95 | 22.40 |
| (mean) [N] | | | | | | |
| Normalized | 1 | 0.155 | 0.490 | 0.809 | 0.981 | 0.958 |
| peak force | | | | | | |

Modeling

In this section, we provide details of our model on unfolding 3D curved surfaces to 2D nets and optimizing the geometries of 2D plies to realize prescribed 3D curved structures with optimal mechanical performance.

Unfolding 3D curved surfaces to 2D nets. To morph flat plies towards a prescribed curved surface with optimized mechanical performance, we first demonstrate the steps of unfolding curved surfaces to valid 2D nets without self-overlapping (see schematic in FIG. 2A):
Discretize the surface to a mesh. Discretize a given smooth surface to a triangular mesh using the open source software MeshLab. The number of the triangular facets of the mesh can be controlled by setting the target number of faces during the mesh generation. In our study, we set the number of the facets N∈[50, 100] to obtain good conformability, reasonable computational cost and high mechanical strength.
Generate the cutting graph. Represent the polyhedral mesh using a cutting graph (dual graph). The cutting graph contains all edges of the mesh and elucidates the connection among the facets of the polyhedral mesh (i.e., the vertices and edges of the cutting graph correspond to the facets and edges of the polyhedral mesh, respectively).
Unfold the mesh to nets. With the cutting graph, one can unfold the mesh to a 2D net by calculating the minimum spanning tree (MST), which is a subset of the edges of the cutting graph that connects all the vertices together without any cycles, and with the minimum total edge weight. By assigning a set of weights to the edges of the cutting graph, we can generate a specific cutting path via the MST. If the edges of the mesh belong to the MST, the edges are used for unfolding. Otherwise, the edges will be cut. In this study, the MST is computed from the cutting graph using the Prim's algorithm.
Moreover, the unfolding net is typically not a valid net that contains multiple overlaps. To obtain valid nets without an overlap, we detect the overlap of each unfolded net by checking if any facets of the nets intersect with each other. To facilitate the generation of non-overlapping nets, we employ different algorithms (including breadth-first unfolding, steepest-edge unfolding, flat-tree unfolding and random-shortest-path unfolding to assign the weights for the cutting graph. Note that other algorithms can also be embedded into our model accordingly.
Add tabs to the nets. To mitigate the cut induced shear lag effect on the mechanical performance of the reconstructed structures, we also add tabs to the cut edges of the 2D nets. Each tab has a trapezoidal geometry which is trimmed from the corresponding triangular facet of the cut edge (see the tabs i and j and their corresponding facets i and j in FIG. 11). With this design, the tabs will not overlap with each other after the plies are wrapped to 3D structures. Moreover, the tabs should have a minimum width w_{tag} to provide enough shear forces to mitigate the mechanical weakness induced by the cuts, but the tags should not be too large since that would cause additional overlaps and, in turn, limit the design space to find the optimized nets. Further, only one tab is added for each pair of the cut edges (see illustration of paired cut edges a-b and c-d in FIG. 11).

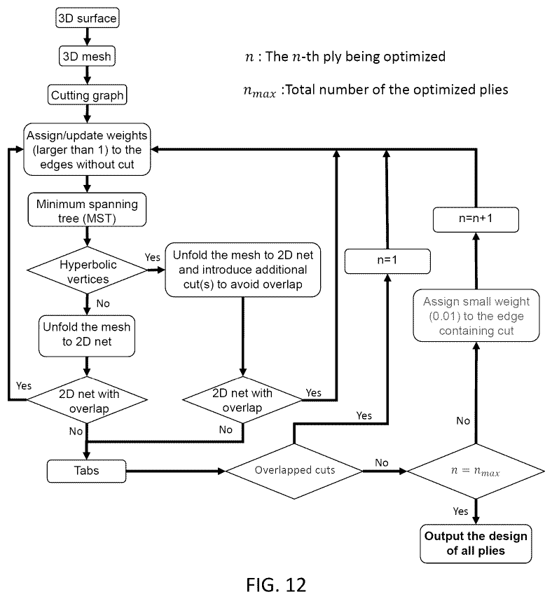

Optimization of the cuts for the plies. After demonstrating the procedure of realizing valid 2D nets from a given 3D surface, we then optimize the cut distribution of each ply to minimize the number of overlapped cuts in the stacked plies. We illustrate the algorithm using a flow chart in FIG. 12 and describe the details of the algorithm in following steps:
Step 1: approximate the 3D surface using a mesh and calculate the cutting graph for the mesh.
Step 2: assign weights to the cutting graph based on different algorithms (breadth-first unfolding, steepest-edge unfolding, flat-tree unfolding and random-shortest-path unfolding) to facilitate the generation of 2D nets without overlap, and unfold the 3D mesh using MST of the cutting graph. Note that we set the weights calculated from the algorithms larger than 1 to differentiate the weight of the edge containing cut in Step 4.
Step 3: check whether the 3D mesh contains hyperbolic nodes. If the mesh contains hyperbolic nodes, introduce minimum number of additional cuts to the unfolded 2D net to avoid self-overlap induced by the hyperbolic nodes and check if the new net, which typically comprises multiple patches, is overlap-free net. Otherwise, check the overlap of the net directly. If the net is not overlap-free, repeat Step 2 and Step 3 until an overlap-free net is found. Then, add tabs for the valid net.
Step 4: optimization for other plies. Check the number of overlapped cuts of the optimized ply (plies), if more than one cut overlaps at the same edge. The optimization will restart from Step 2. Otherwise, assign a small weight (0.01) to the cutting graph's edges that have one cut among the plies, and update the weights of other edges. Note that we assume that the cut can be ignored if the tab is added. Then, when we calculate the MST for the next ply, the edges with small weights will probably not be cut again. Then, the overlap of the ply will check and tabs will be added to the valid ply accordingly. This procedure will be repeated until the target number of plies nₘₐₓ, is achieved.
5: Output the optimized plies.

Note that, to realize a structure comprising more than nₘₐₓ plies, one can simply repeat the optimized plies until the target thickness is reached. The optimization algorithms are implemented in Matlab.

Additional Illustrative Results

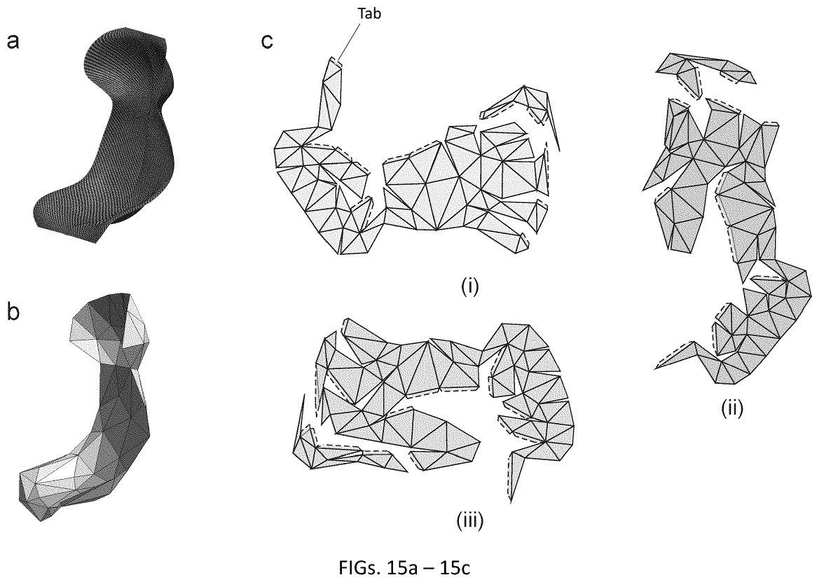

In this section, we demonstrate the capability of our model for the optimization of diverse structures, including a semi-ellipsoidal surface (FIGS. 13A-13C), a helmet (FIGS. 14A-14C) and a racing seat (FIGS. 15A-15C).

Aspects

The following Aspects are illustrative only and do not limit the scope of the present disclosure or the appended claims. Any part or parts of any one or more Aspects can be combined with any part or parts of any one or more other Aspects.

Aspect 1. A method of forming a three-dimensional (3-D) target object having a surface, the method comprising:
with a cutting graph corresponding to a two-dimensional (2-D) representation of a polyhedral mesh that is representative of the 3-D target object, forming i sheets in conformity with the cutting graph,
i being from 1 to n, an i-th 2-D sheet having an i-th set of cuts formed therein, an (i+1)-th 2-D sheet having a (i+1)-th set of cuts formed therein, the (i+1)-th set of cuts optionally differing from the i-th set of cuts,
the sets of cuts being arranged in the n 2-D sheets such that when the n 2-D sheets are stacked and consolidated to form the 3-D target object, a minimum number of cuts overlap.

Aspect 2. The method of Aspect 1, further comprising stacking and consolidating the n 2-D sheets so as to form the 3-D target object, the consolidating optionally being effected by heating, vacuum, pressure, adhesive, or any combination thereof, and the consolidating optionally comprising superposing the n 2-D sheets over a mold.

Aspect 3. The method of any one of Aspects 1-2, further comprising generating the cutting graph, the cutting graph corresponding to the polyhedral mesh that is representative of the 3-D target object.

Aspect 4. The method of Aspect 3, further comprising generating the polyhedral mesh that is representative of the 3-D target object.

Aspect 5. The method of any one of Aspects 1-4, further comprising effecting placement of at least one tab on a 2-D sheet, the tab extending from an edge of the 2-D sheet so as to at least partially overlap a cut on the 2-D sheet when the n 2-D sheets are stacked and consolidated to form the 3-D target object.

Aspect 6. The method of any one of Aspects 1-5, wherein the set of cuts in at least one 2-D sheet is formed according to the minimum spanning tree (MST) of the cutting graph.

Aspect 7. The method of Aspect 6, wherein the MST is computed using Prim's algorithm and/or Kruskal's algorithm.

Aspect 8. The method of any one of Aspects 1-7, wherein the surface of the 3-D target object includes a positive Gaussian curvature.

Aspect 9. The method of any one of Aspects 1-8, wherein the surface of the 3-D target object includes a negative Gaussian curvature.

Aspect 10. The method of any one of Aspects 1-9, wherein an i-th sheet conforms to essentially the entirety of the surface of the 3-D target object.

Aspect 11. The method of any one of Aspects 1-9, wherein an i-th sheet conforms to a portion of the surface of the 3-D target object.

The disclosed methods can be performed in connection with operating a cutting device, e.g., a device that forms cuts according to the cutting graph. The disclosed methods can also be performed in connection with a 3D printing device, e.g., a device that forms sheets with or without cuts formed therein. The disclosed methods can also be performed in connection with lay-ups (i.e., applying 2D sheets to a support surface, which support surface can be curved) or even in connection with consolidation (e.g., via applying heat).

Aspect 12. A 3-D composite object having a surface, the 3-D composite object comprising:
i stacked and consolidated sheets, i being from 1 to n,
an i-th sheet having an i-th set of cuts formed therein,
an (i+1)-th sheet having a (i+1)-th set of cuts formed therein, the (i+1)-th set of cuts optionally differing from the i-th set of cuts,
the sets of cuts being arranged in the n sheets such that when the n sheets are stacked and consolidated to form the 3-D object, a minimum number of cuts overlap.

Aspect 13. The 3-D composite object of Aspect 12, wherein at least one sheet includes a tab extending from an edge of the sheet so as to at least partially overlap a cut on the same sheet when the n sheets are stacked and consolidated to form the 3-D target object.

Aspect 14. The 3-D composite object of any one of Aspects 12-13, wherein the surface of the 3-D composite object includes a positive Gaussian curvature.

Aspect 15. The 3-D composite object of any one of Aspects 12-14, wherein the surface of the 3-D composite object includes a negative Gaussian curvature.

Aspect 16. The 3-D composite object of any one of Aspects 12-15, wherein an i-th sheet conforms to essentially the entirety of the surface of the 3-D composite object.

Aspect 17. The 3-D composite object of any one of Aspects 12-15, wherein an i-th sheet conforms to a portion of the surface of the 3-D composite object.

Such a 3-D object can be of essentially any shape. Masks, protective gear, seats, cones, body suits, armor, shoes, implants, packaging, implant wrapper, and the like are all suitable 3-D objects.

Aspect 18. A kit for forming a 3-D target object, comprising:
i sheets, i being from 1 to n,
an i-th 2-D sheet having an i-th set of cuts formed therein,
an (i+1)-th 2-D sheet having a (i+1)-th set of cuts formed therein, the (i+1)-th set of cuts differing from any other n−1 sets of cuts,
the i sheets being formed in accordance with a cutting graph corresponding to a two-dimensional (2-D) representation of a polyhedral mesh that is representative of the 3-D target object.

Aspect 19. The kit of Aspect 18, wherein the n sheets comprise a material such that when the n sheets are stacked and consolidated to form a testing dog bone having the highest cut density and minimum cut spacing (i.e., distance between cuts) of the kit of Aspect 18, the testing dog bone has a uniaxial mean strength of within 75%, within 25%, or within 10% of the uniaxial mean strength of an equivalent testing dog bone comprising n stacked and consolidated uncut sheets of the material. Without being bound to any particular theory or embodiment, one can conceptualize the dog bone as representing the weakest section (i.e., the section with the maximum number of through thickness cuts and the closest spacing between cuts in-plane) of a 3D part formed from cut 2D sheets.

Aspect 20. The kit of any one of Aspects 18-19, wherein then sheets comprise a material such that when the n sheets are consolidated and stacked to form a flat rectangular plate, a portion of the rectangular plate having a highest cut density and a minimum distance between cuts found in the kit in Aspect 18 is characterized as having a peak force as measured with a three-point bending test of within 75%, within 25%, or within 10% of the peak force of an equivalent flat rectangular plate comprising n stacked and consolidated uncut sheets of the material.

### REFERENCES

Pikul, J. et al. Stretchable surfaces with programmable 3d texture morphing for synthetic camouflaging skins. Science 358, 210-214 (2017).
Kim, S.-U. et al. Broadband and pixelated camouflage in inflating chiral nematic liquid crystalline elastomers. Nat. Mater. (2021).
Siéfert, E., Reyssat, E., Bico, J. & Roman, B. Programming curvilinear paths of flat inflatables. Proc. Natl. Acad. Sci. 116, 16692-16696 (2019).
Konakovic'-Lukovic', M Panetta, J., Crane, K. & Pauly, M. Rapid deployment of curved surfaces via programmable auxetics. ACM Transactions on Graph. (TOG) 37, 1-13 (2018).
Callens, S. J. & Zadpoor, A. A. From flat sheets to curved geometries: Origami and kirigami approaches. Mater. Today 21, 241-264 (2018).
Melancon, D., Gorissen, B., Garcia-Mora, C. J., Hoberman, C. & Bertoldi, K. Multistable inflatable origami structures at the metre scale. Nature 592, 545-550 (2021).
Payne, C. J. et al. Force control of textile-based soft wearable robots for mechanotherapy. In 2018 IEEE International Conference on Robotics and Automation (ICRA), 5459-5465 (IEEE, 2018).
Preston, D. J. et al. A soft ring oscillator. Sci. Robotics 4 (2019).
Siéfert, E., Reyssat, E., Bico, J. & Roman, B. Bio-inspired pneumatic shape-morphing elastomers. Nat. materials 18, 24-28 (2019).
Jin, L., Forte, A. E., Deng, B., Rafsanjani, A. & Bertoldi, K. Kirigami-inspired inflatables with programmable shapes. Adv. Mater. 32, 2001863 (2020).
Panetta, J. et al. Computational inverse design of surface-based inflatables. ACM Transactions on Graph. (TOG) 40, 1-14 (2021).
Forte, A. E. et al. Inverse design of inflatable soft membranes through machine learning. Adv. Funct. Mater. 2111610 (2022).
Kim, J., Hanna, J. A., Byun, M., Santangelo, C. D. & Hayward, R. C. Designing responsive buckled surfaces by halftone gel lithography. Science 335, 1201-1205 (2012).
Guseinov, R., McMahan, C., Pérez, J., Daraio, C. & Bickel, B. Programming temporal morphing of self-actuated shells. Nat. communications 11, 1-7 (2020).
Tao, Y. et al. Morphing pasta and beyond. Sci. Adv. 7, eabf4098 (2021).
Hajiesmaili, E. & Clarke, D. R. Reconfigurable shape-morphing dielectric elastomers using spatially varying electric fields. Nat. communications 10, 1-7 (2019)
Aharoni, H., Xia, Y., Zhang, X., Kamien, R. D. & Yang, S. Universal inverse design of surfaces with thin nematic elastomer sheets. Proc. Natl. Acad. Sci. 115, 7206-7211 (2018).
Dudte, L. H., Vouga, E., Tachi, T. & Mahadevan, L. Programming curvature using origami tessellations. Nat. materials 15, 583-588 (2016).
Choi, G. P., Dudte, L. H. & Mahadevan, L. Programming shape using kirigami tessellations. Nat. materials 8, 999-1004 (2019).
Mangalgiri, P. Composite materials for aerospace applications. Bull. Mater. Sci. 22, 657-664 (1999).
Al-Qureshi, H. Automobile leaf springs from composite materials. J. materials processing technology 118, 58-61 (2001).
Jenkins, M. Materials in sports equipment, vol. 1 (Elsevier, 2003).
Ramakrishna, S., Mayer, J., Wintermantel, E. & Leong, K. W. Biomedical applications of polymer-composite materials: a review. Compos. science technology 61, 1189-1224 (2001).
Campbell, D. T. & Cramer, D. R. Hybrid thermoplastic composite ballistic helmet fabrication study. Adv. Mater. & Process. Eng. (2008).
Dangora, L. M., Mitchell, C. J., Sherwood, J. & Parker, J. C. Deep-drawing forming trials on a cross-ply thermoplastic lamina for helmet preform manufacture. J. Manuf. Sci. Eng. 139, 031009 (2017).
Cho, Y. et al. Engineering the shape and structure of materials by fractal cut. Proc. Natl. Acad. Sci. 111, 17390-17395 (2014).
Celli, P. et al. Shape-morphing architected sheets with non-periodic cut patterns. Soft matter 14, 9744-9749 (2018).
Chen, T., Panetta, J., Schnaubelt, M. & Pauly, M. Bistable auxetic surface structures. ACM Transactions on Graph. (TOG) 40, 1-9 (2021).
Julius, D., Kraevoy, V. & Sheffer, A. D-charts: Quasi-developable mesh segmentation. In Computer Graphics Forum, vol. 24, 581-590 (Citeseer, 2005).
Bern, M. et al. Ununfoldable polyhedra with convex faces. Comput. Geom. 24, 51-62 (2003).
Takahashi, S., Wu, H.-Y., Saw, S. H., Lin, C.-C. & Yen, H.-C. Optimized topological surgery for unfolding 3d meshes. In Computer graphics forum, vol. 30, 2077-2086 (Wiley Online Library, 2011).
Straub, R. & Prautzsch, H. Creating optimized cut-out sheets for paper models from meshes (Karlsruhe Institute of Technology, 2011).
Xi, Z., Kim, Y.-H., Kim, Y. J. & Lien, J.-M. Learning to segment and unfold polyhedral mesh from failures. Comput. & Graph. 58, 139-149 (2016).
Dodd, P. M., Damasceno, P. F. & Glotzer, S. C. Universal folding pathways of polyhedron nets. Proc. Natl. Acad. Sci. 115, E6690-E6696 (2018).
Lee, Y.-K. et al. Computational wrapping: A universal method to wrap 3d-curved surfaces with nonstretchable materials for conformal devices. Sci. advances 6, eaax6212 (2020).
Prim, R. C. Shortest connection networks and some generalizations. The Bell Syst. Tech. J. 36, 1389-1401 (1957).
Korpitsch, T., Takahashi, S., Gröller, E. & Wu, H.-Y. Simulated annealing to unfold 3d meshes and assign glue tabs. In Proceedings of the 28th International Conference in Central Europe on Computer Graphics, 1-10 (2020).
Reissner, E. Analysis of shear lag in box beams by the principle of minimum potential energy. Q. applied mathematics 4, 268-278 (1946).
Easterling, W. S. & Giroux, L. G. Shear lag effects in steel tension members. Eng. J. 3, 77-89 (1993).
Nairn, J. A. On the use of shear-lag methods for analysis of stress transfer in unidirectional composites. Mech. Mater. 26, 63-80 (1997).
Dezi, L., Gara, F., Leoni, G. & Tarantino, A. M. Time-dependent analysis of shear-lag effect in composite beams. J. Eng. Mech. 127, 71-79 (2001).
Chen, Q., Boisse, P., Park, C. H., Saouab, A. & Bréard, J. Intra/inter-ply shear behaviors of continuous fiber reinforced thermoplastic composites in thermoforming processes. Compos. structures 93, 1692-1703 (2011).
Arteiro, A., Furtado, C., Catalanotti, G., Linde, P. & Camanho, P. Thin-ply polymer composite materials: a review. Compos. Part A: Appl. Sci. Manuf. 132, 105777 (2020).
Orench, I. P., Calleja, F. B., Hine, P. & Ward, I. A microindentation study of polyethylene composites produced by hot compaction. J. applied polymer science 100, 1659-1663 (2006).
Cain, J. J. & Staniszewski, J. M. Modeling the nonlinear behavior of uhmwpe laminates using optimized ply-level properties with stepwise fiber-angle rotations. Tech. Rep., DEVCOM Army Research Laboratory (2021).
Cline, J. & Love, B. The effect of in-plane shear properties on the ballistic performance of polyethylene composites. Int. J. Impact Eng. 143, 103592, DOI: https://doi.org/10.1016/j.ijimpeng.2020.103592 (2020).
Orench I P, Calleja F B, Hine P, Ward I (2006) A microindentation study of polyethylene composites produced by hot compaction. Journal of applied polymer science 100(2):1659-1663.
Kartikeya K, Chouhan H, Ahmed A, Bhatnagar N (2020) Determination of tensile strength of uhmwpe fiber-reinforced polymer composites. Polymer Testing 82:106293.
Cignoni P, et al. (2008) Meshlab: an open-source mesh processing tool. in Eurographics Italian chapter conference. (Salerno, Italy), Vol. 2008, pp. 129-136.
Prim R C (1957) Shortest connection networks and some generalizations. The Bell System Technical Journal 36(6):1389-1401.
Korpitsch T, Takahashi S, Gröller E, Wu H Y (2020) Simulated annealing to unfold 3d meshes and assign glue tabs.
Schlickenried W (1997) Nets of polyhedra. Unpublished. Technische Universitat Berlin.

What is claimed:

1. A method of forming a three-dimensional (3-D) target object having a surface, the method comprising:
with a cutting graph corresponding to a two-dimensional (2-D) representation of a polyhedral mesh that is representative of the 3-D target object,
forming i sheets in conformity with the cutting graph,
i being from 1 to n,
an i-th 2-D sheet having an i-th set of cuts formed therein,
an (i+1)-th 2-D sheet having a (i+1)-th set of cuts formed therein, the (i+1)-th set of cuts optionally differing from the i-th set of cuts,
the sets of cuts being arranged in the n 2-D sheets such that when the n 2-D sheets are stacked and consolidated to form the 3-D target object, a minimum number of cuts overlap.

2. The method of claim 1, further comprising stacking and consolidating the n 2-D sheets so as to form the 3-D target object, the consolidating optionally being effected by heating, vacuum, pressure, adhesive, or any combination thereof, and the consolidating optionally comprising superposing the n 2-D sheets over a mold.

3. The method of claim 1, further comprising generating the cutting graph, the cutting graph corresponding to the polyhedral mesh that is representative of the 3-D target object.

4. The method of claim 3, further comprising generating the polyhedral mesh that is representative of the 3-D target object.

5. The method of claim 1, further comprising effecting placement of at least one tab on a 2-D sheet, the tab extending from an edge of the 2-D sheet so as to at least partially overlap a cut on the 2-D sheet when the n 2-D sheets are stacked and consolidated to form the 3-D target object.

6. The method of claim 1, wherein the set of cuts in at least one 2-D sheet is formed according to the minimum spanning tree (MST) of the cutting graph.

7. The method of claim 6, wherein the MST is computed using Prim's algorithm and/or Kruskal's algorithm.

8. The method of claim 1, wherein the surface of the 3-D target object includes a positive Gaussian curvature.

9. The method of claim 1, wherein the surface of the 3-D target object includes a negative Gaussian curvature.

10. The method of claim 1, wherein an i-th sheet conforms to essentially the entirety of the surface of the 3-D target object.

11. The method of claim 1, wherein an i-th sheet conforms to a portion of the surface of the 3-D target object.

12. A 3-D composite object having a surface, the 3-D composite object comprising:
i stacked and consolidated sheets, i being from 1 to n,
an i-th sheet having an i-th set of cuts formed therein,
an (i+1)-th sheet having a (i+1)-th set of cuts formed therein, the (i+1)-th set of cuts optionally differing from the i-th set of cuts,
the sets of cuts being arranged in the n sheets such that when the n sheets are stacked and consolidated to form the 3-D object, a minimum number of cuts overlap.

13. The 3-D composite object of claim 12, wherein at least one sheet includes a tab extending from an edge of the sheet so as to at least partially overlap a cut on the same sheet when the n sheets are stacked and consolidated to form the 3-D composite object.

14. The 3-D composite object of claim 12, wherein the surface of the 3-D composite object includes a positive Gaussian curvature.

15. The 3-D composite object of claim 12, wherein the surface of the 3-D composite object includes a negative Gaussian curvature.

16. The 3-D composite object of claim 12, wherein an i-th sheet conforms to essentially the entirety of the surface of the 3-D composite object.

17. The 3-D composite object of claim 12, wherein an i-th sheet conforms to a portion of the surface of the 3-D composite object.

18. A kit for forming a 3-D target object, comprising:
i sheets,
i being from 1 to n,
an i-th 2-D sheet having an i-th set of cuts formed therein,
an (i+1)-th 2-D sheet having a (i+1)-th set of cuts formed therein, the (i+1)-th set of cuts differing from any other n−1 sets of cuts,
the i sheets being formed in accordance with a cutting graph corresponding to a two-dimensional (2-D) representation of a polyhedral mesh that is representative of the 3-D target object.

19. The kit of claim 18, wherein the n sheets comprise a material such that when the n sheets are stacked and consolidated to form a testing dog bone, having the highest cut density and minimum cut spacing from in the kit of claim 18, where the testing dog bone has a uniaxial mean strength of within 75%, within 25%, or within 10% of the uniaxial mean strength of an equivalent testing dog bone comprising n stacked and consolidated uncut sheets of the material.

20. The kit of claim 18, wherein the n sheets comprise a material such that when the n sheets are consolidated and stacked to form a rectangular plate, a portion of the rectangular plate having a highest cut density and a minimum distance between cuts found in the kit in claim 18 is characterized as having a peak force as measured with a three-point bending test of within 75%, within 25%, or within 10% of the peak force of an equivalent rectangular plate comprising n stacked and consolidated uncut sheets of the material.
